(19) United States
(12) Patent Application Publication
(10) Pub. No.: US 2013/0283948 A1
(43) Pub. Date: Oct. 31, 2013

(54) MASSAGE APPARATUS

(71) Applicant: Yuan-Chuen Chen, Changhua (TW)

(72) Inventor: Yuan-Chuen Chen, Changhua (TW)

(73) Assignee: HSIN HAO HEALTH MATERIALS CO., LTD., CHANGHUA (TW)

(21) Appl. No.: 13/457,934

(22) Filed: Apr. 27, 2012

(51) Int. Cl. F16H 55/02

(52) U.S. Cl. 74/89.28

(57) ABSTRACT

A massage apparatus having a power source that can be a motor producing forward and reverse movement, and an active gear attached to a protruding axis from the power source. The active gear engages with a passive gear on a horizontal transmission stick to transmit the power, and the power source can drive a vertical transmission stick through a steering gear group, so that the horizontal transmission stick and vertical transmission stick can generate simultaneous forward and reverse movement. Also, a transmission gear is disposed on the horizontal transmission stick, and a conjugated gear is disposed on a one-way bearing of a horizontal threaded rod that is parallel to the horizontal transmission stick. Furthermore, a massaging unit is conjugated with pairs of horizontal transmission sticks, horizontal threaded rods, vertical transmission sticks and vertical threaded rods through a sliding cover.

### FIELD OF THE INVENTION

The present invention relates to a massage apparatus, and more particularly to a massage apparatus having threaded rods that can be driven forward and reversely, and the massage apparatus may stay at a fixed point to conduct massage.

### BACKGROUND OF THE INVENTION

With the booming economy, people pay more attention to the quality of life, however, people also endure a certain degree of pressure in life, family and work, which cause a heavy burden to people both physically and mentally. Thus, it is particularly important for people to release pressure both physically and mentally, and massage is the most common way to achieve this goal. However, massage service is usually provided by a trained specialist and the service is usually provided within a specific time frame, so that people may not be able to enjoy the massage service at the time and place according to his/her preference. Also, it may be costly for a long period of time. Therefore, a number of massage devices have come out.

Conventional massage devices are of linear sliding rail style, which is triggered by a driving stick on one side to drive a massaging unit on the rail to move forward/backward or up/down. Although the massaging unit can move to most parts of the body, it cannot pause at a specific point to massage the aching portion of the body. Therefore, there remains a need for a new and improved massage apparatus to overcome the problems stated above.

### SUMMARY OF THE INVENTION

The technical problem the present invention wants to solve is that although the massaging unit can move to most parts of the body, it cannot pause at a specific point to massage the aching portion of the body. Therefore, there remains a need for a new and improved massage apparatus to overcome the problems stated above.

To solve and overcome the problems stated above, the present invention provides a massage apparatus having a power source that can be a motor producing forward and reverse movement, and an active gear attached to a protruding axis from the power source. The active gear engages with a passive gear on a horizontal transmission stick to transmit the power, and the power source can drive a vertical transmission stick through a steering gear group, so that the horizontal transmission stick and vertical transmission stick can generate simultaneous forward and reverse movement. Also, a transmission gear is disposed on the horizontal transmission stick, and a conjugated gear is disposed on a one-way bearing of a horizontal threaded rod that is parallel to the horizontal transmission stick. The transmission gear and the conjugated gear engage with each other through a decelerating gear group. Through the steering gear group, the conjugated gear can drive a vertical threaded rod so that the horizontal threaded rod and the vertical threaded rod can simultaneously rotate in a single direction. Furthermore, a massaging unit is conjugated with pairs of horizontal transmission sticks, horizontal threaded rods, vertical transmission sticks and vertical threaded rods through a sliding cover.

Comparing with the conventional arts, the present invention is advantageous because (a) using the one-way bearing, the horizontal threaded rod and the vertical threaded rod, along with the power source with forward and reverse rotations, the massaging unit can achieve the goal of massaging in different parts of the body, as well as the fixed point massage to receive a more relaxed massaging effect; and (b) using the one-way bearing, the horizontal threaded rod and the vertical threaded rod, the number of the transmission components are reduced and it becomes more easily to assemble the apparatus.

### BRIEF DESCRIPTION OF THE DRAWINGS

FIG. 1 illustrates a three-dimensional view in the present invention.

FIG. 2 illustrates a three-dimensional exploded view in the present invention.

FIG. 3 illustrates a partially enlarged view of FIG. 2.

FIG. 4 illustrates the power source rotating toward one direction when in use in the present invention.

FIG. 5 illustrates a three-dimensional view of the power source rotating toward one direction when in use in the present invention.

FIG. 6 illustrates the power source rotating toward the other direction when in use in the present invention.

FIG. 7 illustrates a three-dimensional view of the power source rotating toward the other direction when in use in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

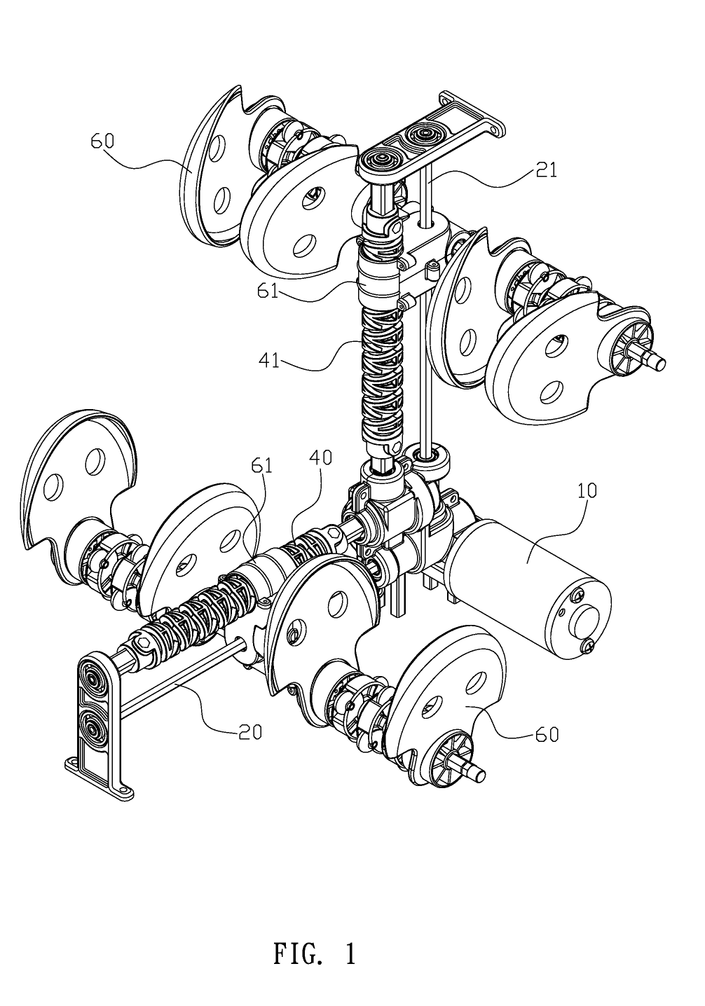

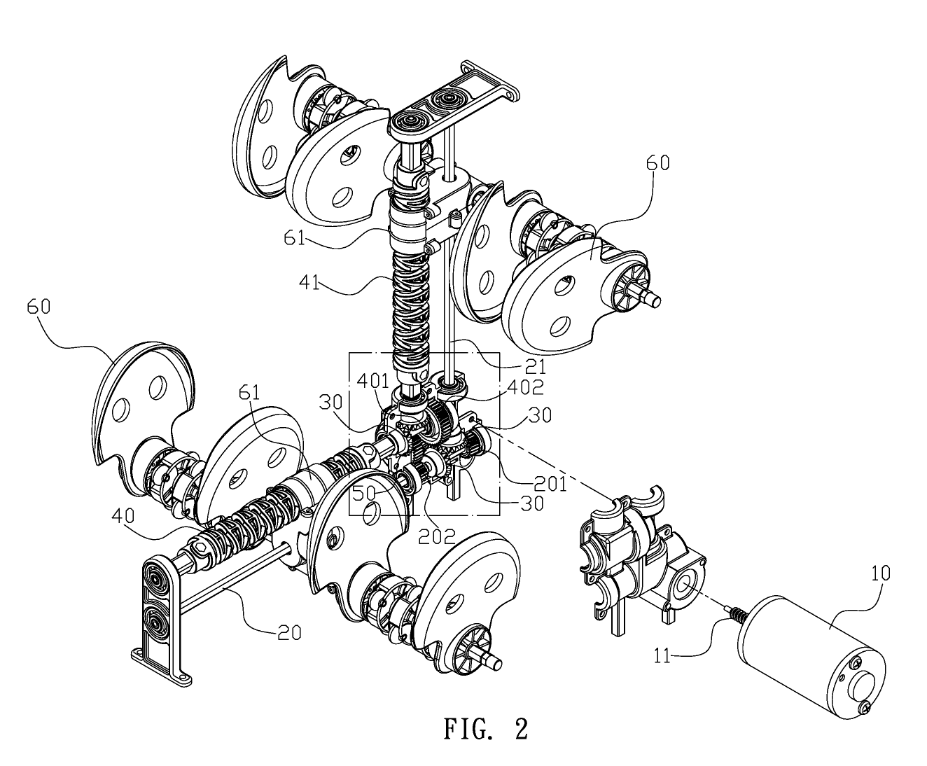

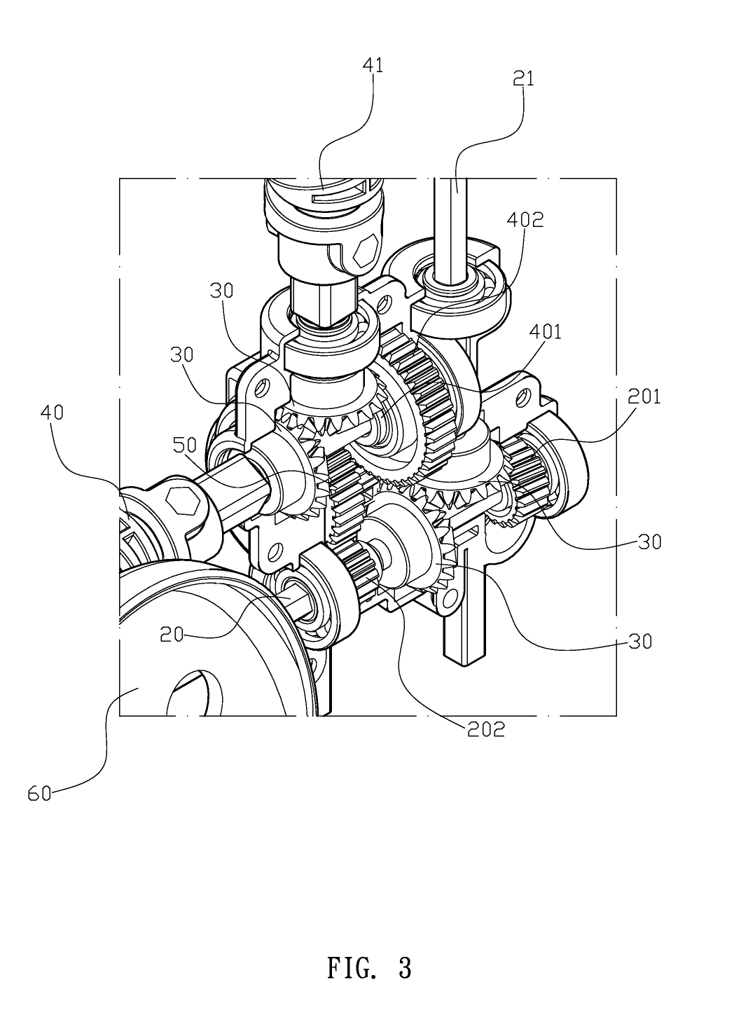

Referring to FIGS. 1 to 3, an assembled structure includes a massage apparatus includes a power source (10) that can be a motor producing forward and reverse movement, and an active gear (11) is attached to a protruding axis from the power source. The active gear (11) engages with a passive gear (201) on a horizontal transmission stick (20) to transmit the power, and the power source (10) can drive a vertical transmission stick (21) through a steering gear group (30), so that the horizontal transmission stick (20) and vertical transmission stick (21) can generate simultaneous forward and reverse movement. Also, a transmission gear (202) is disposed on the horizontal transmission stick (20), and a conjugated gear (402) is disposed on a one-way bearing (401) of a horizontal threaded rod (40) that is parallel to the horizontal transmission stick (20). The transmission gear (202) and the conjugated gear (402) engage with each other through a decelerating gear group (50). Through the steering gear group (30), the conjugated gear (402) can drive a vertical threaded rod (41) so that the horizontal threaded rod (40) and the vertical threaded rod (41) can simultaneously rotate in a single direction. Furthermore, a massaging unit (60) is conjugated with pairs of horizontal transmission sticks (20), horizontal threaded rods (40), vertical transmission sticks (21) and vertical threaded rods through a sliding cover (61).

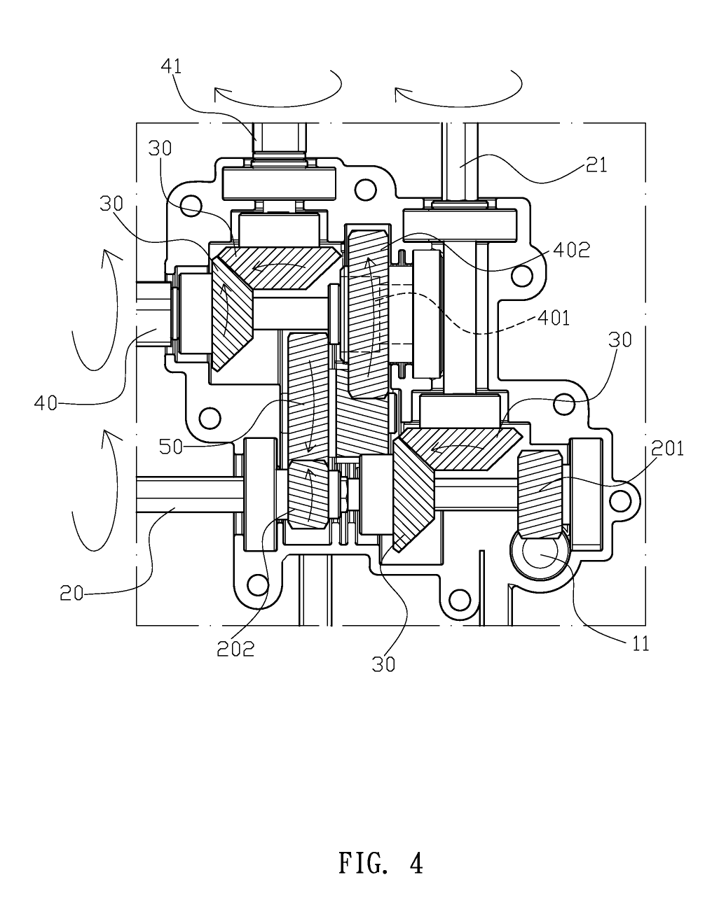

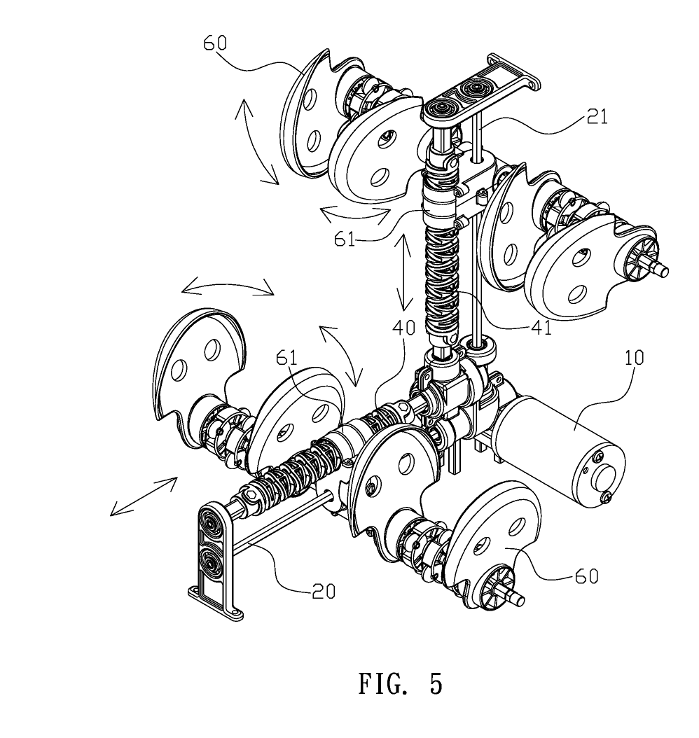

According to the structure described above, when the power source (10) rotates to one direction (see FIGS. 4 and 5), the active gear (11) engages with the passive gear (201) to drive the horizontal transmission stick (20), and the vertical transmission stick (21) can be driven at the same time through the steering gear group (30), so that the two massaging units (60) on the horizontal transmission stick (20) and the vertical transmission stick (21) can continuously swing to achieve the goal of massage. Because of the engagement of the transmission gear (202), decelerating gear group (50) and conjugated gear (402), the power can be transmitted through the steering gear group (30), and the horizontal threaded rod (40) and the vertical threaded rod (41) can be rotated with reducing speed. In other words, the threaded rod acts in concert with the sliding cover (61) to convert the rotating movement to linear movement so that the massaging unit (60) can freely move forward, backward, up and down to massage most parts of the body.

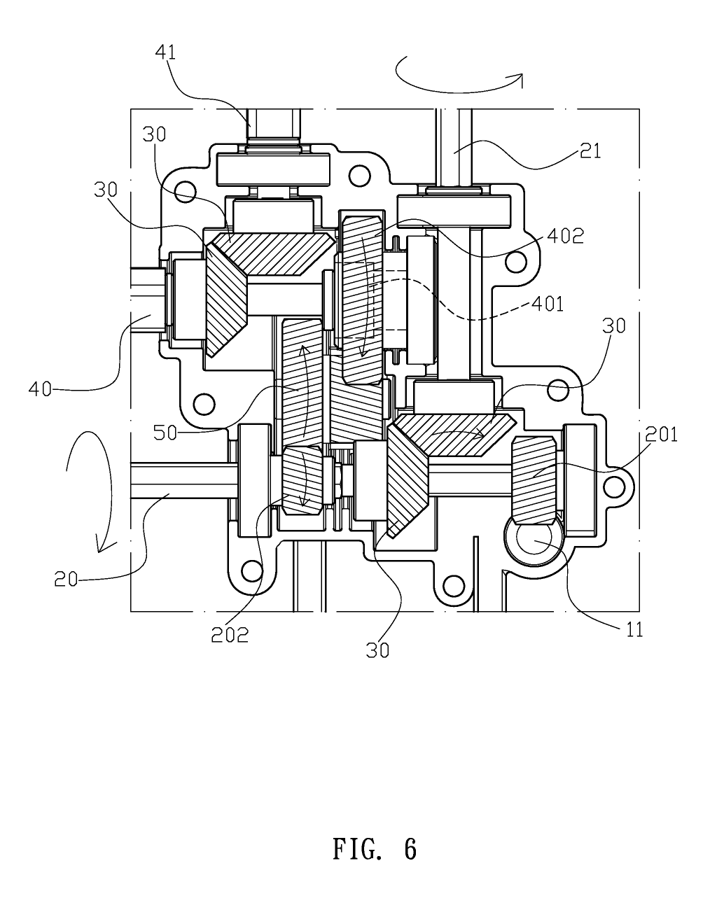

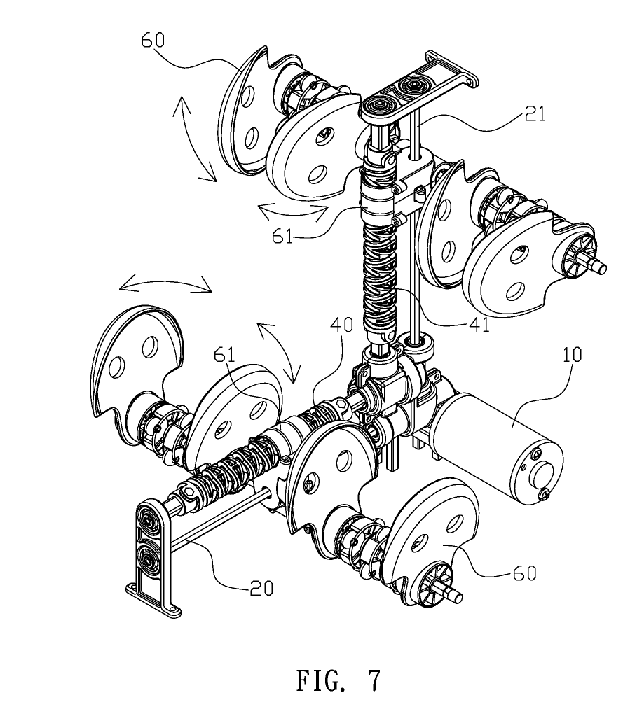

On the other hand, if the power source (10) rotates to the other direction (see FIGS. 6 and 7), the one-way bearing (401) and the horizontal threaded rod (40) are idling, so the power cannot be transmitted to the massaging unit (60) to generate movement, and the massaging unit (60) stays at a fixed point to conduct massage with increased intensity.

According to the embodiments discussed above, the present invention has following advantages: (a) using the one-way bearing (401), the horizontal threaded rod (40) and the vertical threaded rod (40), along with the power source (10) with forward and reverse rotations, the massaging unit can achieve the goal of massaging in different parts of the body, as well as the fixed point massage to receive a more relaxed massaging effect; and (b) using the one-way bearing (401), the horizontal threaded rod (40) and the vertical threaded rod (40), the number of the transmission components are reduced and it becomes more easily to assemble the apparatus.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A massage apparatus comprising: a power source producing forward and reverse movement, and an active gear attached to a protruding axis from the power source, wherein the active gear engages with a passive gear on a horizontal transmission stick to transmit the power, and the power source drives a vertical transmission stick through a steering gear group, so that the horizontal transmission stick and vertical transmission stick generate simultaneous forward and reverse movement, wherein a transmission gear is disposed on the horizontal transmission stick, and a conjugated gear is disposed on a one-way bearing of a horizontal threaded rod that is parallel to the horizontal transmission stick, and the transmission gear and the conjugated gear engage with each other through a decelerating gear group, wherein the conjugated gear drives a vertical threaded rod through the steering gear group, so that the horizontal threaded rod and the vertical threaded rod can simultaneously rotate in a single direction, wherein a massaging unit is conjugated with pairs of horizontal transmission sticks, horizontal threaded rods, vertical transmission sticks and vertical threaded rods through a sliding cover.

2. The massage apparatus of claim 1, wherein the power source is a motor producing forward and reverse movement.

3. The assembled structure of claim 1, wherein the transmission gear and the conjugated gear engage with each other through a decelerating gear group.

4. The assembled structure of claim 1, wherein a massaging unit is conjugated with pairs of horizontal transmission sticks, horizontal threaded rods, vertical transmission sticks and vertical threaded rods through a sliding cover.
